(19) United States
(12) Patent Application Publication
(10) Pub. No.: US 2013/0077567 A1
(43) Pub. Date: Mar. 28, 2013

(54) WIRELESS TERMINAL, GATEWAY SELECTION METHOD, AND WIRELESS NETWORK SYSTEM

(71) Applicants: Hiroshi Fujita, Yokosuka (JP); Yun Wen, Kawasaki (JP); Makoto Yoshida, Yokohama (JP)

(72) Inventors: Hiroshi Fujita, Yokosuka (JP); Yun Wen, Kawasaki (JP); Makoto Yoshida, Yokohama (JP)

(73) Assignee: FUJITSU LIMITED, Kawasaki-shi (JP)

(21) Appl. No.: 13/559,756

(22) Filed: Jul. 27, 2012

(30) Foreign Application Priority Data
Sep. 26, 2011 (JP) 2011-208627

(51) Int. Cl. H04W 4/00

(52) U.S. Cl. 370/328

(57) ABSTRACT

A wireless terminal includes a detection section that detects, from a packet received from a plurality of gateways, a control packet broadcast from the plurality of gateways, a candidate specifying section that specifies a plurality of gateways as candidates for connection from a sender gateway that sent the detected control packet, and a selection section that selects one of the specified gateways as a gateway for establishment of connection.

### CROSS-REFERENCE TO RELATED APPLICATION

This application is based upon and claims the benefit of priority of the prior Japanese Patent Application No. 2011-208627, filed on Sep. 26, 2011, the entire contents of which is incorporated herein by reference.

### FIELD

Embodiment discussed herein is related to a wireless terminal, a gateway selection method, and a wireless network system.

### BACKGROUND

Wireless terminals that construct a wireless ad-hoc network receive information on paths to gateways from surrounding terminals to select a gateway for establishment of connection, for example. The term “wireless ad-hoc network” refers to a wireless network automatically constructed by the wireless terminals to transfer data to a destination in a bucket brigade manner. The term “gateway” refers to a device that serves as an interface between a wired network and a wireless network.

The gateways, which are directly connected to a wired network, are limited in terms of installation range to the location of installation of the wired network, and therefore have a low degree of freedom in installation. Meanwhile, the wireless terminals have a high degree of freedom in installation, and may be disposed geologically unevenly. When the wireless terminals are disposed unevenly with respect to the locations of installation of the gateways, connections may be made unevenly to a specific gateway to cause concentration of network load. In order to suppress uneven concentration of network load on a specific gateway, load distribution is desirable. Japanese Laid-open Patent Publication No. 2005-079827 and Japanese Laid-open Patent Publication No. 2009-81854, for example, discuss a technique of selecting a connection path from a wireless terminal to a gateway.

### SUMMARY

According to an aspect of the invention, a wireless terminal includes a detection section that detects, from a packet received from a plurality of gateways, a control packet broadcast from the plurality of gateways, a candidate specifying section that specifies a plurality of gateways as candidates for connection from a sender gateway that sent the detected control packet, and a selection section that selects one of the specified gateways as a gateway for establishment of connection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a wireless ad-hoc network system;

FIG. 2 is a hardware block diagram of a wireless terminal;

FIG. 3 is a functional block diagram of the wireless terminal;

FIG. 4 illustrates the data structure of a HELLO packet;

FIG. 5 is a flowchart of a process of selecting a gateway for establishment of connection with the wireless terminal;

FIG. 6 illustrates the distribution of the number of gateways with respect to the path cost;

FIG. 7 is a functional block diagram of a wireless terminal;

FIG. 8 is a detailed flowchart of a statistical information calculation process performed by a controller;

FIG. 9 illustrates how connection paths to the gateway are narrowed;

FIG. 10 is a flowchart of a process of narrowing the connection paths to the gateway; and

FIG. 11 is a graph illustrating the effect of the embodiment.

### DESCRIPTION OF EMBODIMENT

Hereinafter, an embodiment will be described.

While inventing the present embodiments, observations were made regarding a related art. Such observations include the following, for example.

In a wireless ad-hoc network of a related art, exchanging messages between wireless terminals and gateways to select a connection path from a wireless terminal to a gateway may increase a wireless resource. In addition, varying the reachable range (number of hops) of a HELLO packet, which is a packet carrying path information and sent by a gateway, in accordance with the load on the gateway may make connection between the wireless terminal and the gateway unstable.

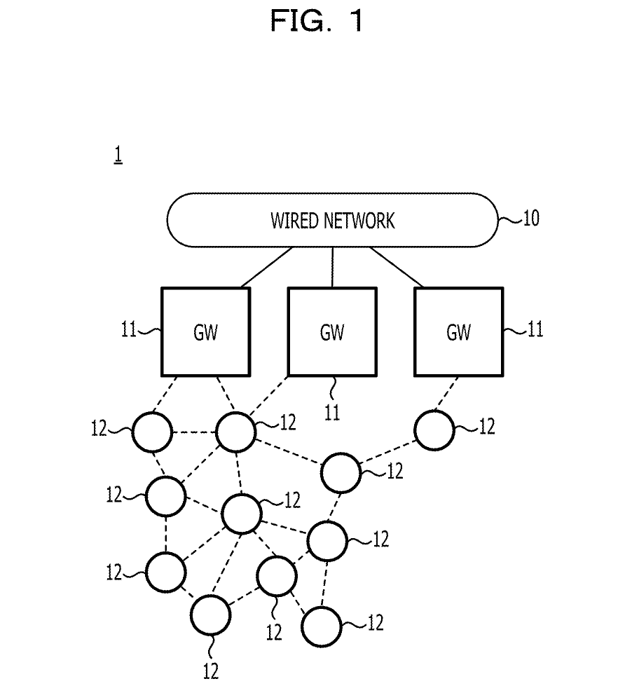

FIG. 1 is a block diagram of a wireless ad-hoc network system 1. The wireless ad-hoc network system 1 includes a wired network 10, a plurality of gateways (GWs) 11, and a plurality of wireless terminals 12. Solid lines connecting between the wired network 10 and the gateways 11 indicate wired connections. Dotted lines connecting between the wireless terminals 12 and between the wireless terminals 12 and the gateways 11 indicate wireless connections.

The wired network 10 is a communication network formed by wired connections. The plurality of wireless terminals 12 have a function of constructing a wireless ad-hoc network. The gateways 11 function as an interface that relays connection between the wired network 10 and the wireless ad-hoc network.

The plurality of wireless terminals 12 autonomously construct a wireless ad-hoc network. Each wireless terminal 12 randomly selects one of a plurality of connectable gateways 11 based on the path cost of the connection path between the gateway 11 and the wireless terminal 12. The term “path cost” as used herein is a value decided in accordance with the length from the wireless terminal 12 to the gateway 11, the number of hops provided between the wireless terminal 12 and the gateway 11, or the like. The path cost may also be a value calculated using as a parameter the accumulated value of received power, the error rate of data, deviation in timing to receive a HELLO packet, or the like.

Each wireless terminal 12 distributes a HELLO packet, which is a packet carrying path information, as a message for constructing a path to the gateway 11. Other wireless terminals 12 receiving the HELLO packet calculate the path cost of the path from the wireless terminal 12 to the gateway 11. The wireless terminals 12 distribute the calculated path cost as a HELLO packet. The wireless terminals 12 repeatedly receive and distribute HELLO packets to autonomously construct a wireless ad-hoc network. The wireless terminals 12 and the construction of the wireless ad-hoc network will be discussed in detail later.

The wireless terminals 12 constructing the wireless ad-hoc network can thus be connected to the wired network 10 via one of the plurality of gateways 11.

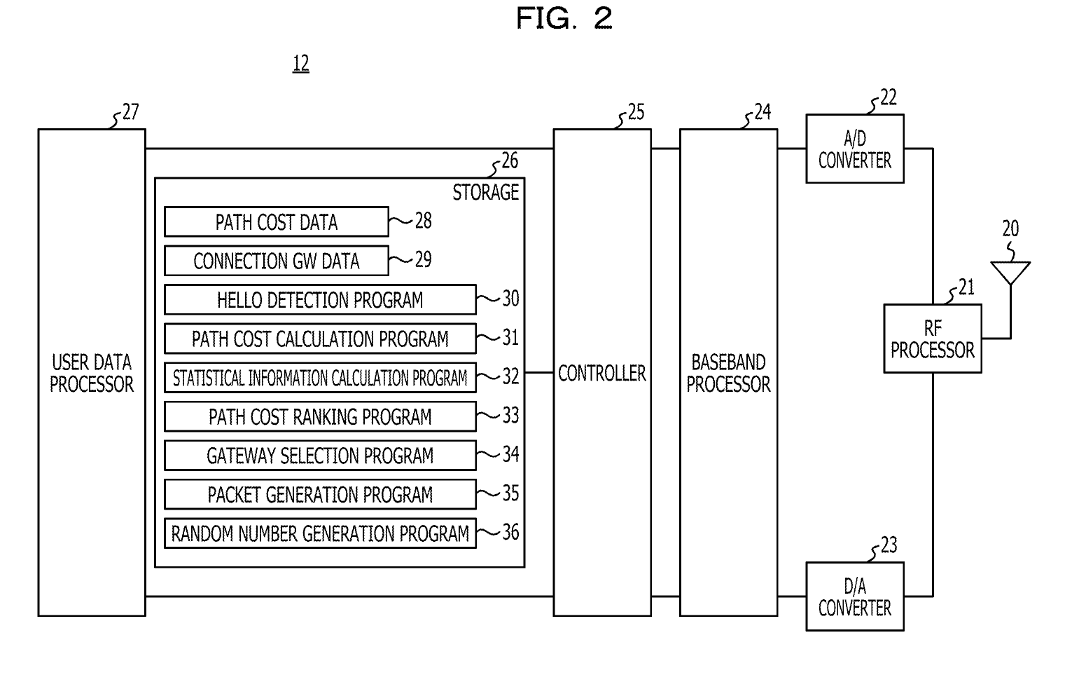

FIG. 2 is a hardware block diagram of the wireless terminal 12. The wireless terminal 12 includes an antenna 20, a radio-frequency (RF) processor 21, an analog/digital (A/D) converter 22, a digital/analog (D/A) converter 23, a baseband processor 24, a controller 25, a storage 26, and a user data processor 27.

The antenna 20 is used for wireless communication between the wireless terminal 12 and other devices. The RF processor 21 modulates an analog signal output from the D/A converter 23 using a frequency selected in accordance with the communication scheme. The D/A converter 23 converts a digital signal output from the baseband processor 24 into an analog signal to output the analog signal to the RF processor 21. The A/D converter 22 converts an analog signal output from the RF processor 21 into a digital signal to output the digital signal to the baseband processor 24.

The baseband processor 24 performs digital processing on data for transmission in accordance with the communication scheme to output the data to the D/A converter 23. The controller 25 reads and executes programs stored in the storage 26 to achieve various functions. The controller 25 may be a central processing unit (CPU), for example. The storage 26 stores data and programs. The storage 26 may be a read only memory (ROM) or a random access memory (RAM), for example. The data and the programs stored in the storage 26 will be discussed in detail later. The user data processor 27 provides various functions to a user of the wireless terminal 12.

The storage 26 includes path cost data 28, connection gateway (GW) data 29, a HELLO detection program 30, a path cost calculation program 31, a statistical information calculation program 32, a path cost ranking program 33, a gateway selection program 34, a packet generation program 35, and a random number generation program 36.

The path cost data 28 are data on the path cost of the communication path for communication between the wireless terminal 12 and each connectable gateway 11. The connection GW data 29 are data indicating information on the gateway 11 to be connected with the wireless terminal 12.

The HELLO detection program 30 is a program that causes the controller 25 to execute a process of detecting a HELLO packet from data received from the baseband processor 24. The path cost calculation program 31 is a program that causes the controller 25 to calculate the total path cost of the path to each connectable gateway 11 based on path cost information extracted from the received HELLO packet.

The statistical information calculation program 32 is a program that causes the controller 25 to perform statistical processing on the distribution of the path cost for connection to each connectable gateway 11. The path cost ranking program 33 is a program that causes the controller 25 to rank the selectable gateways 11 in accordance with the path cost based on the results of the statistical processing for the path cost. The gateway selection program 34 is a program that causes the controller 25 to randomly select one of the ranked gateways 11 based on a random number generated by the random number generation program 36 to be discussed later.

The packet generation program 35 is a program that causes the controller 25 to generate a packet that notifies the selected gateway 11 of establishment of connection. The random number generation program 36 is a program that causes the controller 25 to generate a random number as discussed earlier.

The wireless terminal 12 can thus cause the controller 25 to execute the programs stored in the storage 26 to suppress uneven concentration of network load on a specific gateway 11.

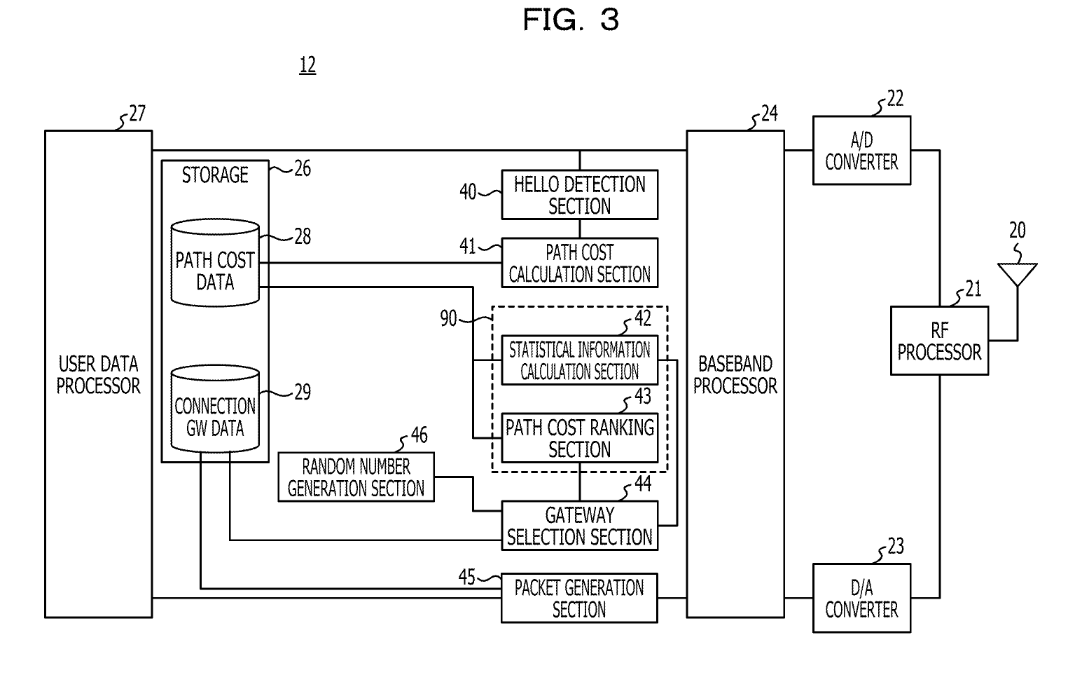

FIG. 3 is a functional block diagram of the wireless terminal 12. Each functional block is implemented by the controller 25 executing a program read from the storage 26. The wireless terminal 12 includes the antenna 20, the RF processor 21, the A/D converter 22, the D/A converter 23, the baseband processor 24, a HELLO detection section 40, a path cost calculation section 41, a candidate specifying section 90, a gateway selection section 44, a packet generation section 45, a random number generation section 46, the storage 26, and the user data processor 27. The candidate specifying section 90 narrows gateways as candidates for connection based on the calculated path cost. The candidate specifying section 90 includes a statistical information calculation section 42 and a path cost ranking section 43. The storage 26 stores the path cost data 28 and the connection GW data 29.

Members of the wireless terminal 12 in FIG. 3 that are the same as those of the wireless terminal 12 in FIG. 2 are denoted by the same reference numerals to omit overlapping description. In FIG. 3, the HELLO detection section 40 is implemented by the controller 25 executing the HELLO detection program 30 stored in the storage 26. The path cost calculation section 41 is implemented by the controller 25 executing the path cost calculation program 31 stored in the storage 26. The statistical information calculation section 42 is implemented by the controller 25 executing the statistical information calculation program 32 stored in the storage 26. The path cost ranking section 43 is implemented by the controller 25 executing the path cost ranking program 33 stored in the storage 26. The gateway selection section 44 is implemented by the controller 25 executing the gateway selection program 34 stored in the storage 26. The packet generation section 45 is implemented by the controller 25 executing the packet generation program 35 stored in the storage 26. The random number generation section 46 is implemented by the controller 25 executing the random number generation program 36 stored in the storage 26.

The wireless terminal 12 in FIG. 2 can thus be represented by functional blocks as illustrated in FIG. 3. In the embodiment, each functional block is implemented by the controller 25 executing a program stored in the storage 26. However, each functional block may be implemented by a digital circuit using an application-specific integrated circuit (ASIC) or the like.

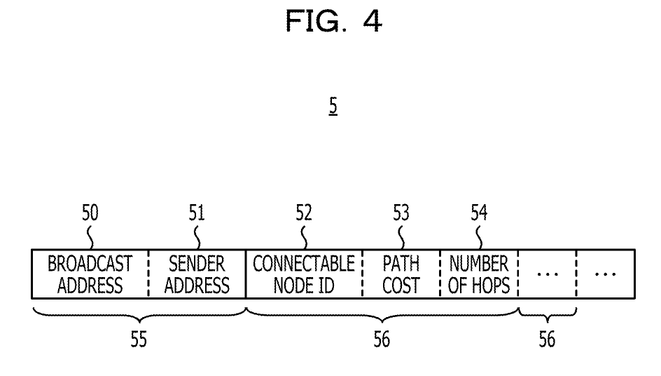

FIG. 4 illustrates the data structure of a HELLO packet 5. The HELLO packet 5 is a packet of data containing information on a path from the wireless terminal 12 which sent the packet to each gateway 11. The HELLO packet 5 is transmitted from each wireless terminal 12. A wireless terminal 12 can decide the gateway 11 for establishment of connection by analyzing HELLO packets 5 received from other wireless terminals 12.

The HELLO packet 5 includes a header 55 and a plurality of pieces of destination path information 56. The header 55 contains data indicating the wireless terminal 12 sending the HELLO packet 5. The header 55 includes a broadcast address 50 and a sender address 51. The broadcast address 50 is an address indicating the fact that the HELLO packet 5 is broadcast. The fact that the HELLO packet 5 is broadcast indicates that the HELLO packet 5 is sent to no specific recipient. The sender address 51 is a specific address assigned to the wireless terminal 12 sending the packet. The specific address may be a media access control (MAC) address, for example.

The destination path information 56 contains information on the connection path from the wireless terminal 12 sending the HELLO packet 5 to a wirelessly connectable gateway 11. The destination path information 56 is provided for each gateway 11 that is connectable to the wireless terminal 12 sending the packet. The destination path information 56 includes a connectable node ID 52, a path cost 53, and a number of hops 54. The connectable node ID 52 indicates the identification number of the gateway 11 that is connectable to the wireless terminal 12 sending the HELLO packet 5. A specific identification number has been assigned to each gateway 11. The path cost 53 is information on the path cost decided by the connection path from the wireless terminal 12 sending the HELLO packet 5 to the gateway 11 indicated by the connectable node ID 52. The number of hops 54 indicates the number of wireless terminals 12 by way of which connection is established from the wireless terminal 12 sending the HELLO packet 5 to the gateway 11 indicated by the connectable node ID 52.

The wireless terminal 12 can thus acquire information on the connectable gateways 11 and the path costs for the connectable gateways 11 by analyzing HELLO packets 5 received from other wireless terminals 12.

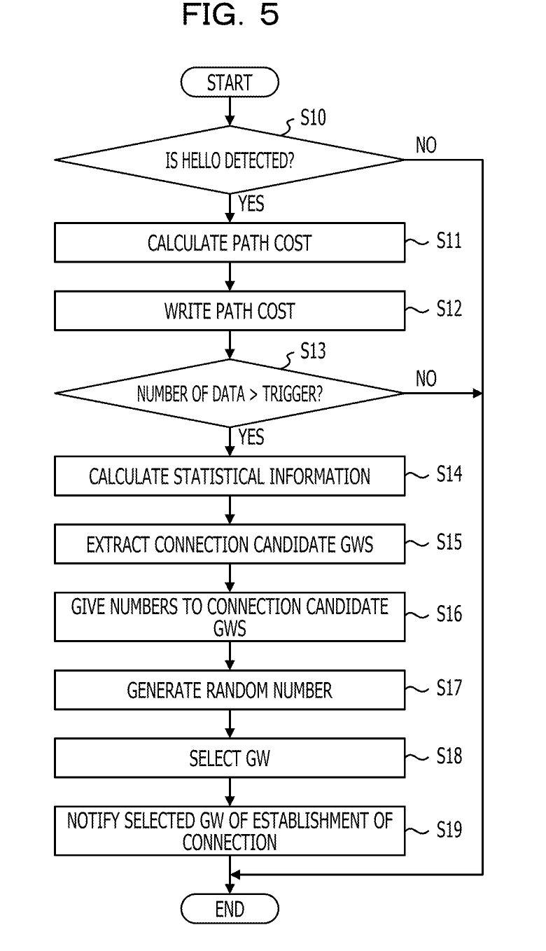

FIG. 5 is a flowchart of a process of selecting a gateway 11 for establishment of connection. The process in FIG. 5 is executed by the controller 25 of the wireless terminal 12.

The controller 25 executes the HELLO detection program 30 to execute a process of detecting a HELLO packet 5 from a received packet of data (S10). In the case where a HELLO packet 5 is detected (S10: YES), the controller 25 proceeds to step S11. In the case where a HELLO packet 5 is not detected (S10: NO), the controller 25 terminates the process of selecting a gateway 11 for establishment of connection.

The controller 25 specifies a different wireless terminal 12 which sent the detected HELLO packet 5. The controller 25 reads the destination path information 56 from the HELLO packet 5. The controller 25 executes the path cost calculation program 31 to add the path cost of the path from the wireless terminal 12 to which the controller 25 belongs to the different wireless terminal 12 to the path cost of the path from the different wireless terminal 12 to a connectable gateway 11 (S11). This allows the controller 25 to calculate the path cost of the path from the wireless terminal 12 to which the controller 25 belongs to the connectable gateway 11. The controller 25 writes the calculated path cost into the storage 26 as the path cost data 28 (S12).

In the case where the number of gateways 11 corresponding to the path cost data 28 written into the storage 26 exceeds a trigger value set in advance (S13: YES), the controller 25 proceeds to step S14. In the case where the number of gateways 11 is equal to or less than the trigger value (S13: NO), the controller 25 repeatedly performs the processes in steps S10 to S12.

The controller 25 executes the statistical information calculation program 32 to calculate the average and the variance of the path costs of the paths from the wireless terminal 12 to which the controller 25 belongs to the gateways 11 as statistical information on the path costs (S14). The controller 25 extracts gateways 11 with a path cost exceeding the average as connection candidate gateways 11 (S15). The calculation of the path information and the extraction of the connection candidate gateways 11 will be discussed in detail later.

The controller 25 executes the path cost ranking program 33 to give sequential numbers to the extracted connection candidate gateways 11 in the ascending order of path cost (S16). The controller 25 executes the random number generation program 36 to generate a random number in the range of the number of the extracted connection candidate gateways 11 (S17). The controller 25 executes the gateway selection program 34 to select a connection candidate gateway 11 given the number matching the generated random number (S18). The controller 25 writes information on the selected gateway 11 into the storage 26 as the connection GW data 29.

The controller 25 executes the packet generation program 35 to generate a packet of data to notify the selected gateway 11 of establishment of connection based on the connection GW data 29 written into the storage 26. The controller 25 transmits the generated packet of data to the gateway 11 to notify the gateway 11 of establishment of connection (S19).

The wireless terminal 12 can thus select a connection path in consideration of load distribution among the gateways 11 without increasing network load.

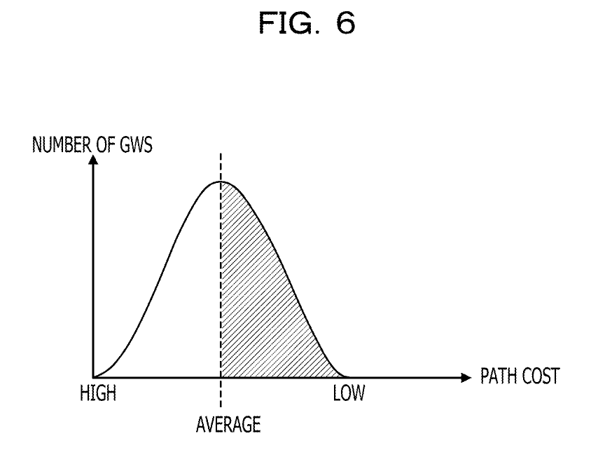

FIG. 6 illustrates the distribution of the number of gateways 11 with respect to the path cost. The distribution of the number of gateways 11 with respect to the path cost is generally as illustrated in FIG. 6. The controller 25 executes the statistical information calculation program 32 to calculate the average of all the path costs of the paths from the wireless terminal 12 to which the controller 25 belongs to the connectable gateways 11 and the variance of the path costs of the paths to the gateways 11.

The controller 25 determines gateways 11 with a path cost larger than the average of the path costs as connection candidate gateways 11. The connection candidate gateways 11 correspond to a hatched portion in the graph of FIG. 6.

The controller 25 can thus set a plurality of connectable gateways 11 based on the path cost to suppress concentration of network load on a specific gateway 11.

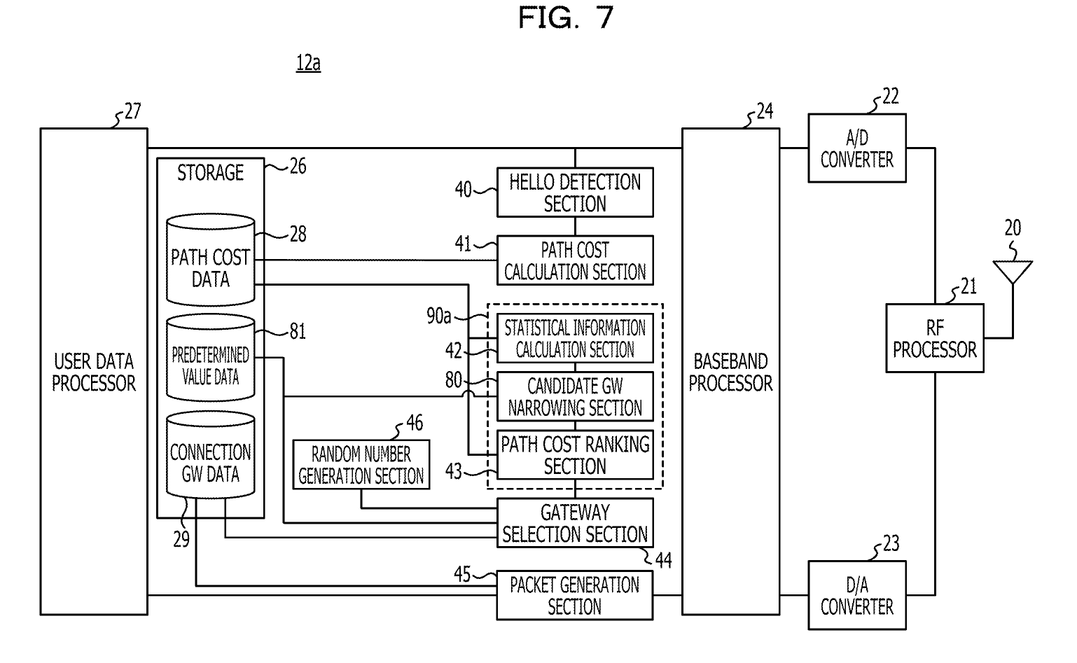

FIG. 7 is a functional block diagram of a wireless terminal 12a. In contrast to the wireless terminal 12, the wireless terminal 12a has a function of narrowing the connection candidate gateways 11 based on the statistical information.

Each functional block of the wireless terminal 12a is implemented by the controller 25 executing a program read from the storage 26. The wireless terminal 12a includes the antenna 20, the RF processor 21, the A/D converter 22, the D/A converter 23, the baseband processor 24, the HELLO detection section 40, the path cost calculation section 41, a candidate specifying section 90a, the gateway selection section 44, the packet generation section 45, the random number generation section 46, the storage 26, and the user data processor 27. The candidate specifying section 90a narrows gateways as candidates for connection based on the calculated path cost. The candidate specifying section 90a includes the statistical information calculation section 42, a candidate GW narrowing section 80, and the path cost ranking section 43. The storage 26 stores the path cost data 28, predetermined value data 81, and the connection GW data 29.

Members of the wireless terminal 12a in FIG. 7 that are the same as those of the wireless terminal 12 in FIG. 3 are denoted by the same reference numerals to omit overlapping description. In contrast to the wireless terminal 12 in FIG. 3, the wireless terminal 12a in FIG. 7 additionally includes the candidate GW narrowing section 80 and the predetermined value data 81.

In the wireless terminal 12a, the controller 25 executes a candidate GW narrowing program stored in the storage 26 to function as the candidate GW narrowing section 80. The candidate GW narrowing section 80 executes a process of narrowing gateways 11 as candidates for connection from the wireless terminal 12a based on the results of comparison between the statistical information calculated by the statistical information calculation section 42 and the predetermined value data 81 stored in the storage 26. A threshold serving as the criterion for determination as to whether or not the connection candidate gateways 11 are to be narrowed is stored as the predetermined value data 81. The operation of the candidate GW narrowing section 80 will be discussed in detail later.

The wireless terminal 12a can thus narrow the connection candidate gateways 11 using the candidate GW narrowing section 80 and the predetermined value data 81.

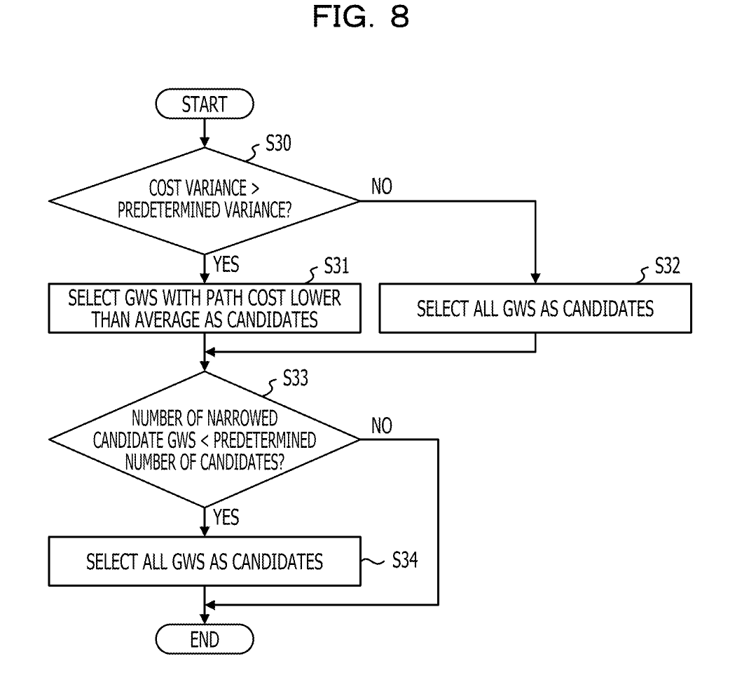

FIG. 8 is a detailed flowchart of a statistical information calculation process performed by the controller 25. In the case where the number of connectable gateways 11 is sufficiently large, there are also a sufficiently larger number of gateways 11 with a path cost lower than the average of the path costs. As a result, the load of the process of selecting a gateway 11 can be relieved by randomly selecting a gateway 11 for establishment of connection from the narrowed connectable gateways 11 with a path cost lower than the average.

In the case where the number of connectable gateways 11 is small, however, there may be a few gateways 11 with a path cost lower than the average of the path costs. In the case where there are a few selectable gateways 11, randomly selecting one gateway 11 from the few gateways 11 is highly likely to cause concentration of network load. Thus, one of the connectable gateways 11 is selected without narrowing the connectable gateways 11 in accordance with the average of the path costs. Concentration of network load can thus be suppressed by omitting the narrowing process in accordance with the number of selectable gateways 11.

The controller 25 compares the cost variance calculated by executing the statistical information calculation program 31 and a predetermined variance stored in the storage 26 as the predetermined value data 81 (S30). In the case where the cost variance is larger than the predetermined variance (S30: YES), the controller 25 selects gateways 11 with a path cost lower than the average of the path costs as the connection candidate gateways 11 (S31). In the case where the cost variance is not larger than the predetermined variance (S30: NO), on the other hand, the controller 25 selects all the gateways 11 as the connection candidate gateways 11 (S32).

The controller 25 compares the number of the narrowed connection candidate gateways 11 with a predetermined number of candidates stored in the storage 26 as the predetermined value data 81 (S33). In the case where the number of the narrowed connection candidate gateways 11 is smaller than the predetermined number of candidates (S33: YES), the controller 25 resets all the gateways 11 as the connection candidate gateways 11 (S34). In the case where the number of the narrowed connection candidate gateways 11 is not smaller than the predetermined number of candidates (S33: NO), the controller 25 terminates the process of narrowing connection candidate gateways.

The controller 25 can thus compare the statistical values of the path costs and the predetermined values set in advance to execute an optimum process of selecting connection candidate gateways 11 matching the statistical values.

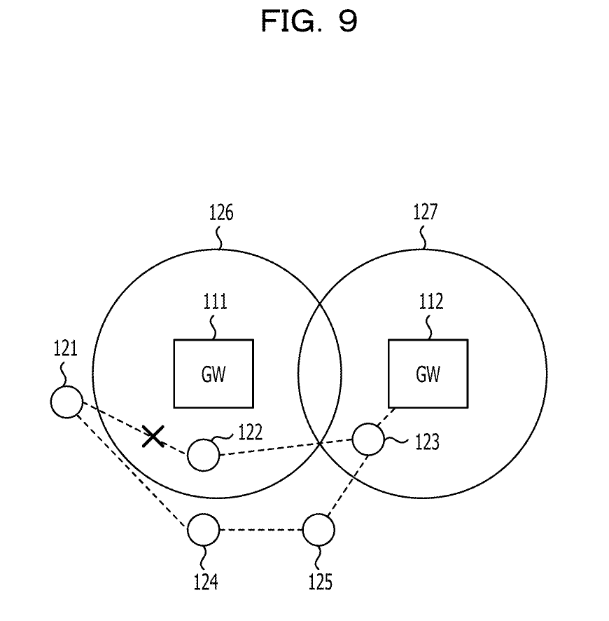

FIG. 9 is a connection path diagram illustrating how connection paths to the gateway 11 are narrowed. In the connection path diagram of FIG. 9, reference numerals 121, 122, 123, 124, and 125 denote separate wireless terminals 12. Reference numerals 111 and 112 denote separate gateways 11. Reference numeral 126 denotes the cell range of the gateway 111. Reference numeral 127 denotes the cell range of the gateway 112.

For connection from the wireless terminal 121 to the gateway 112, a path by way of the wireless terminal 122 and a path by way of the wireless terminal 124 are selectable as illustrated in the connection path diagram of FIG. 9. In general, the path cost is higher as the number of passed wireless terminals 12 by way of which connection is established, that is, the number of hops, is larger. Hence, in the connection path diagram of FIG. 9, the path by way of the wireless terminal 122 results in a path cost lower than that of the path by way of the wireless terminal 124.

Meanwhile, the wireless terminal 122 is located in the cell range 126 of the gateway 111. Hence, a signal wirelessly transmitted from the wireless terminal 122 and a signal wirelessly transmitted from the gateway 111 interfere with each other. Interference between wireless signals degrades the signal quality, as a result of which the path cost of the path by way of the wireless terminal 122 is increased.

Hence, in the case where a wireless terminal 12 provided in the connection path from the wireless terminal 121 to the gateway 112 is located within the area of a gateway 11 different from the gateway 11 for connection, as with the wireless terminal 122, the wireless terminal 121 preferentially selects the path by way of the wireless terminal 124. The wireless terminal 121 can thus avoid a path by way of a wireless terminal 12 that interferes with a different gateway 11 to avoid occurrence of useless interference between wireless signals.

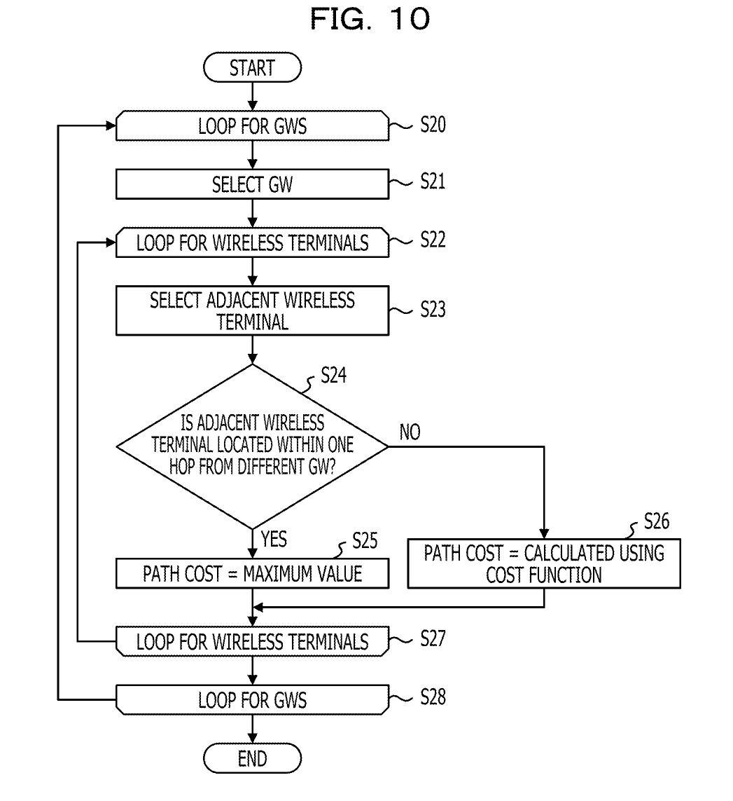

FIG. 10 is a flowchart of a process of narrowing the connection paths to the gateway 112. The flowchart of FIG. 10 is described using the operation of the wireless terminal 121 in FIG. 9 as an example. The process for the wireless terminal 121 is executed by the controller 25 of the wireless terminal 121.

The wireless terminal 121 repeatedly performs the processes in steps S20 to S28 the number of times corresponding to the number of gateways 11. The wireless terminal 121 selects one gateway 11 (S21). In the case of FIG. 9, the gateway 112 is selected as one of the gateways 11.

The wireless terminal 121 repeatedly performs the processes in steps S22 to S27 the number of times corresponding to the number of adjacent wireless terminals 12. The wireless terminal 121 selects one of the adjacent wireless terminals 12 that is connectable to the gateway 11 selected in step S21 (S23). In the case of FIG. 9, the wireless terminals 122 and 124 are selected as the wireless terminals 12 that are adjacent to the wireless terminal 121 and that are located in a connection path to the gateway 112.

The wireless terminal 121 determines whether or not the adjacent wireless terminal 12 is located within one hop from a gateway 11 different from the selected gateway 11 (S24). By the phrase “a wireless terminal 12 is located within one hop from a gateway 11”, it is meant that the wireless terminal 12 is located within the cell range of the gateway 11.

In the case where the adjacent wireless terminal 12 is located within one hop from a different gateway 11 (S24: YES), the wireless terminal 121 sets the path cost of the path by way of the adjacent wireless terminal 12 to the worst value. By setting the path cost to the worst value, the wireless terminal 121 can exclude the path by way of the adjacent wireless terminal 12 from the connection paths to the gateway 112. In the case of FIG. 9, the path cost of the path by way of the adjacent wireless terminal 122 is set to the maximum value.

In the case where the adjacent wireless terminal 12 is not located within one hop from a different gateway 11 (S24: NO), the wireless terminal 121 calculates the path cost of the path by way of the adjacent wireless terminal 12 using a cost function as is normally performed. In the case of FIG. 9, the path cost of the path by way of the adjacent wireless terminal 124 is calculated using a cost function.

The term “cost function” refers to a function for calculation of a path cost. The cost function has as a parameter the distance between nodes from the wireless terminal 12 to the gateway 11 or the number of hops provided between the wireless terminal 12 and the gateway 11. The value of the cost function is larger as the distance between nodes from the wireless terminal 12 to the gateway 11 is longer or the number of hops provided between the wireless terminal 12 and the gateway 11 is larger.

By thus verifying the presence or absence of an adjacent gateway 11 for all the selectable paths for the gateways 11 that are connectable from the wireless terminal 121, the wireless terminal 121 can establish a connection path without unnecessary interference by the adjacent gateway 11.

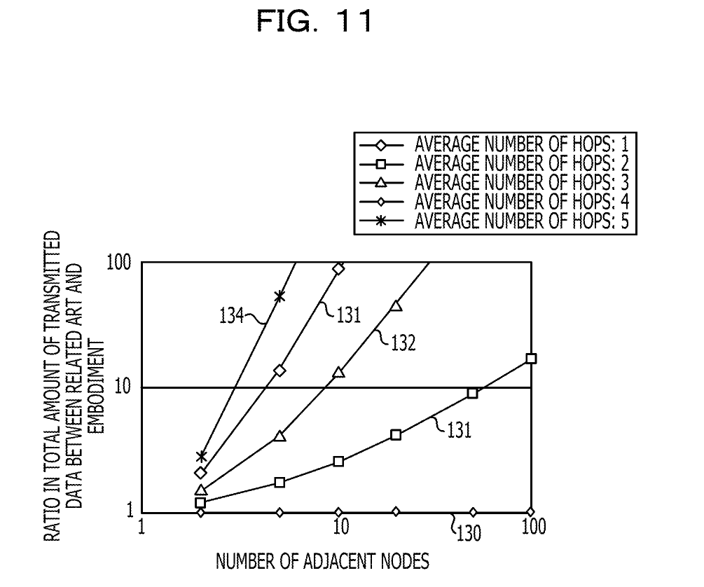

FIG. 11 is a graph illustrating the effect of the embodiment. The term “related art” as used in FIG. 11 refers to a technique in which a gateway receiving a message requesting ad-hoc connection broadcast from a wireless terminal transmits a band-related message and relay terminals provided between the gateway and the wireless terminal add surrounding band information to the band-related message to relay the message to the wireless terminal.

In FIG. 11, a graph 130 is a graph indicating the effect of the embodiment over the related art for a case where the average number of hops from the wireless terminal 12 to the gateway 11 is 1. A graph 131 is a graph indicating the effect of the embodiment over the related art for a case where the average number of hops from the wireless terminal 12 to the gateway 11 is 2. A graph 132 is a graph indicating the effect of the embodiment over the related art for a case where the average number of hops from the wireless terminal 12 to the gateway 11 is 3. A graph 133 is a graph indicating the effect of the embodiment over the related art for a case where the average number of hops from the wireless terminal 12 to the gateway 11 is 4. A graph 134 is a graph indicating the effect of the embodiment over the related art for a case where the average number of hops from the wireless terminal 12 to the gateway 11 is 5.

The wireless terminal 12 according to the embodiment autonomously selects a gateway 11 based on a HELLO packet received from an adjacent wireless terminal 12. Therefore, unlike the related art, response messages are not exchanged between the wireless terminal 12 and the gateway 11. As indicated by the graph 130 in FIG. 11, there is no difference in effect between the related art and the embodiment in the case where the average number of hops is 1. As indicated by the graphs 131 to 134, however, the effect of the embodiment is greater as the average number of hops is larger. In the case where the average number of hops is 2, for example, the effect of the embodiment is about 2.5 times greater than that of the related art when the number of adjacent nodes is 10, as indicated by the graph 131.

The wireless terminal 12 can thus reduce the amount of wireless resource consumed before establishment of wireless ad-hoc connection by autonomously establishing wireless ad-hoc connection with the gateway 11.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless terminal comprising:
a detection section that detects, among a packet received from a plurality of gateways, a control packet broadcast from the plurality of gateways;
a candidate specifying section that specifies a plurality of gateways as candidates for connection from a sender gateway that sent the detected control packet; and
a selection section that selects one of the specified gateways as a gateway for establishment of connection.

2. The wireless terminal according to claim 1, wherein
the candidate specifying section calculates a path cost based on a quality of a wireless signal transmitted through a connection path to each connectable gateway to specify the gateways as candidates for connection based on the calculated path cost.

3. The wireless terminal according to claim 2, wherein
the candidate specifying section specifies the gateways as candidates for connection based on results of comparison between statistical information on the path cost for each gateway and a threshold set in advance.

4. The wireless terminal according to claim 2, wherein
the candidate specifying section sets a value of the path cost of a connection path to a maximum value in the case where a different wireless terminal forming the connection path is located within a communication area of a gateway different from the gateway selected for establishment of connection.

5. The wireless terminal according to claim 1, wherein
the selection section randomly selects one gateway.

6. A gateway selection method comprising:
detecting, at a wireless terminal connectable to a plurality of gateways, a control packet broadcast from the plurality of gateways, among a packet received from the plurality of gateways;
specifying a plurality of gateways as candidates for connection from a sender gateway that sent the detected control packet; and
selecting one of the specified gateways as a gateway for establishment of connection with the wireless terminal.

7. The wireless terminal according to claim 6, wherein
the specifying calculates a path cost based on a quality of a wireless signal transmitted through a connection path to each connectable gateway to specify the gateways as candidates for connection based on the calculated path cost.

8. The wireless terminal according to claim 7, wherein
the specifying specifies the gateways as candidates for connection based on results of comparison between statistical information on the path cost for each gateway and a threshold set in advance.

9. The wireless terminal according to claim 7, wherein
the specifying sets a value of the path cost of a connection path to a maximum value in the case where a different wireless terminal forming the connection path is located within a communication area of a gateway different from the gateway selected for establishment of connection.

10. The wireless terminal according to claim 6, wherein
the selecting randomly selects one gateway.

11. A storage medium that stores a gateway selection program that causes a wireless terminal, which selects a gateway for establishment of connection based on a control packet broadcast from a plurality of gateways, to:
detect from a packet received from the plurality of gateways a control packet broadcast from the plurality of gateways;
specify a plurality of gateways as candidates for connection from a sender gateway that sent the detected control packet; and
select one of the specified gateways.
